(19) United States
(12) Patent Application Publication
(10) Pub. No.: US 2020/0136970 A1
(43) Pub. Date: Apr. 30, 2020

(54) NETWORK SWITCH AND METHOD OF PROCESSING DATA FRAME FOR THE SAME

(71) Applicant: DASAN Zhone Solutions, Inc., Oakland, CA (US)

(72) Inventors: Seung Dong LEE, Fremont, CA (US); Kyoung Soo KIM, Seongnam-si (KR)

(73) Assignee: DASAN Zhone Solutions, Inc.

(21) Appl. No.: 16/174,255

(22) Filed: Oct. 29, 2018

(51) Int. Cl. H04L 12/741; H04L 12/721

(52) U.S. Cl. CPC H04L 45/745; H04L 45/66

(57) ABSTRACT

Disclosed is new enhanced technology for a media access control (MAC) address table management method of a network switch. When a frame is received by a port other than a previous receiving port and a difference between a recorded final reception time and a current reception time is smaller than a guard threshold, the network switch does not perform MAC movement. The guard threshold may be empirically determined in consideration of network characteristics.

### BACKGROUND

### 1. Field

The present invention relates to a network switch, and more particularly, to a method of managing a media access control (MAC) address table using the network switch.

### 2. Discussion of Related Art

A network switch transmits a network data frame, which is received by one port, to one or more ports determined for the frame to reach destination equipment. Network equipment refers to a media access control (MAC) address table (MAT) in forwarding the frame. When a frame with a MAC source address that is not listed in the MAT is received through a specific port, the network switch registers the MAC source address and corresponding port identification information in the MAT. This process is called dynamic MAC address learning. When a frame with a MAC source address is received from a port different from a port that is registered in the MAT and that corresponds to the MAC source address, the network switch updates port information so that the MAC source address is registered for the different port. This process is called MAC movement.

When a frame with a MAC destination address that is not listed in the MAT is received, the network switch floods the frame to all ports of the same virtual local area network (LAN) except for the port used to receive the frame. In this case, when a loop is between multiple paths through which a packet is transferred, the packet is repeatedly and infinitely forwarded over the same path. To prevent this situation, Ethernet defines and uses the Spanning Tree Protocol (STP). However, the STP manages a specific port to be blocked and prevents occurrence of a loop, and thus a link cannot be efficiently used. Also, some equipments do not support the corresponding protocol.

### SUMMARY

The proposed invention is directed to increasing efficiency of a network switch by restricting unnecessary MAC movement.

Furthermore, the proposed invention is directed to preventing occurrence of a loop by improving MAC address learning.

According to an aspect, when a frame is received by a port other than a previous receiving port and a difference between a recorded final reception time and a current reception time is smaller than a guard threshold, the network switch does not perform MAC movement. The guard threshold may be empirically determined in consideration of network characteristics.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram showing a configuration of a network switch according to an embodiment;

FIG. 2 is a flowchart showing a data frame processing method according to an embodiment of the proposed invention;

FIG. 3 illustrates the frame processing method of FIG. 2 and shows a case in which example packets are received by an example network switch; and

FIG. 4 is a block diagram showing a detailed configuration of the network switch according to an embodiment.

### DETAILED DESCRIPTION OF EXEMPLARY EMBODIMENTS

The above or other aspects will be implemented through embodiments described with reference to the accompanying drawings. It is to be understood that the components of each embodiment may be variously combined therein unless otherwise stated or mutually contradictory. That is, although each drawing is shown as one embodiment, it should not be understood as being limited to one embodiment. As will be described in separate optional or additional aspects, it is to be understood that one or more unessential blocks are combined as essential blocks to represent a variety of embodiments.

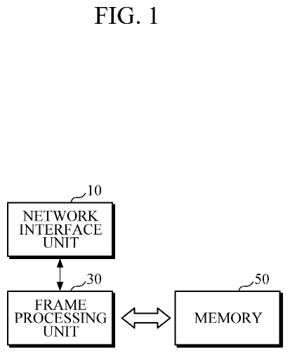

FIG. 1 is a block diagram showing a configuration of a network switch according to an embodiment. The network switch according to an embodiment includes a network interface unit 10, a memory 50, and a frame processing unit 30. The network interface unit 10 includes a physical network port and a communication semiconductor chip connected to the port and configured to form a physical layer. In the shown embodiment, the network interface unit 10 is responsible for processing the physical layer. The memory 50 includes a program and management data including a media access control (MAC) address table (MAT). Generally, the MAT manages the following items.

VLAN: MAC ADDRESS: TYPE(STATIC, DYNAMIC): PORTS

VLAN indicates virtual local area network (LAN) network identification information regarding a virtual LAN through which a corresponding frame is received, and MAC ADDRESS indicates a source MAC address in the corresponding received frame. TYPE indicates type information of a corresponding entry and is recorded as STATIC when the entry is directly input by a manager and as DYNAMIC when the entry is acquired through dynamic MAC address learning. PORTS indicates identification information of a port that has received a corresponding frame. The frame processing unit 30 processes a frame received through the network interface unit 10 and transmits the processed frame to the network interface unit 10. For example, the frame processing unit 30 may include a microprocessor and dedicated hardware devices used to help speed up some analysis functions for data frames.

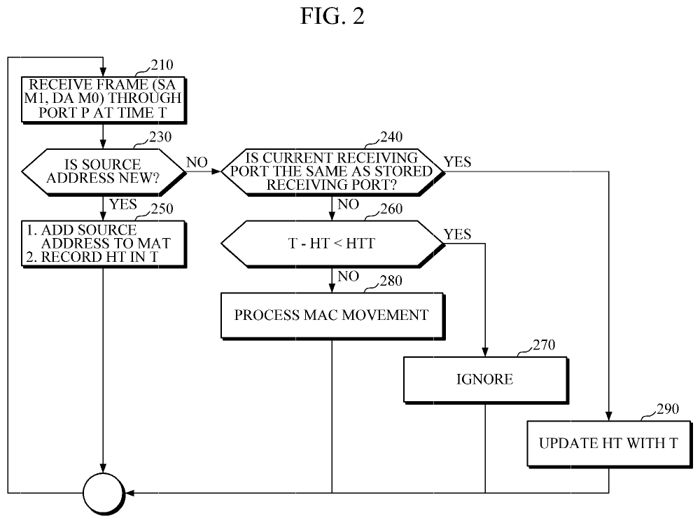

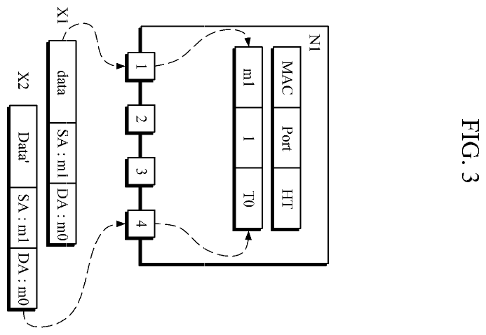

FIG. 2 is a flowchart showing a data frame processing method according to an embodiment of the proposed invention. FIG. 3 illustrates the frame processing method of FIG. 2 and shows a case in which example packets are received by an example network switch. The items “VLAN,” “TYPE,” and the like will be omitted from the MAT shown in FIG. 3. According to an aspect of the proposed invention, the shown MAT further includes an item “HT.” Here, the item “HT” refers to a guard threshold according to the proposed invention and will be described below. However, the item “HT” does not have to be included in the MAT, but may be managed in the memory as a separate item or table.

For example, the shown data frame processing method may be implemented in the frame processing unit 30 of FIG. 1 by using software. The data frame processing method according to an embodiment of the proposed invention will be described as being processed by a frame processing unit. However, the proposed invention is not limited thereto, and it should be understood that the frame processing unit refers to one or a plurality of hardware devices, each of which is a processing entity.

According to an aspect, a port that has received a frame may be different from a previous receiving port for a corresponding MAC address. In this case, the data frame processing method includes updating port identification information recorded in the source MAC address with identification information of the current receiving port only when a difference between a time at which the frame is finally received from a corresponding source MAC address and a time at which the current frame is received is greater than a guard threshold.

With the data frame processing method according to an embodiment, first, a frame is received through a port of the network switch in a frame receiving step 210. As shown in FIG. 3, a data frame X1 is received at a time T0 through a port of a network switch N1, for example, a port with an identification number P1. As illustrated, the data frame has a source MAC address m1 and a destination MAC address m0.

According to an embodiment, the data frame processing method may include a source MAC search step 230. In the source MAC search step 230, a frame processing unit of the network switch N1 searches a MAT for the source MAC address of the received frame. When a corresponding address is not found from the MAT, that is, when the source MAC address of the received frame is a new address, which is not registered in the MAT, a new entry is generated in the MAT, and the source MAC address, that is, m1 (see FIG. 3) is registered in a MAT entry addition step 250. In this case, receiving port information for the MAC address m1 in the entry generated in the MAT is recorded as the port that has received the frame, which is referred to as P1. According to an aspect, in the entry of the new source MAC address, the time at which the corresponding frame is received, that is, T1, is recorded in the item “HT.” Although not shown in FIG. 2, the frame processing unit of the network switch may additionally process the frame X1 after step 250. For example, when the destination address m0 of the frame X1 is found from the MAT, the frame processing unit transmits the frame X1 to a port recorded in a corresponding entry of the MAT. As another example, when the destination address m0 of the frame X1 is not found from the MAT, the frame X1 is flooded to all the ports except for the receiving port, that is, P1.

After the additional frame processing ends, a data frame X2 is received through one port of the network switch N1, for example, a port with an identification number P4 at a time T1 in the frame receiving step 210, as shown in FIG. 3. As illustrated, this data frame has a source MAC address m1 and a destination MAC address m0, like the frame X1. In the source MAC search step 230, the frame processing unit of the network switch N1 searches the MAT for the source MAC address m1 of the received frame.

Subsequently, in the port identification information comparison step 240, the frame processing unit of the network switch N1 compares the port identification information P1 recorded for the source MAC address m1 of the received frame to the identification information P4 of the port that has received the current frame. The comparison result is that the current receiving port is the same as the stored receiving port. Thus, in a reference comparison step 260, the frame processing unit of the network switch N1 computes a difference between the stored time HT at which the frame is finally received from the source MAC address, for example, the time T0 and a time T1 at which the current frame is received, that is, T0−T1, and compares the difference to a guard threshold HTT. When the difference T1−T0 is greater than the guard threshold HTT, the MAC movement occurs. That is, in the port identification information update step 280, the port information in the entry of the source MAC m1 of the MAT is updated from the old P1 to the new P4. In this case, the value T0 recorded in the item “HT” of the MAT may be overwritten with the value T1, which is initial time information received through the port P4. However, in this case, optionally, the item “HT” may be processed to be maintained. According to an aspect, when the difference T1−T0 is smaller than the guard threshold HTT, the method proceeds to a MAC movement preventing step 270. Thus, the MAC movement does not occur, and the packet reception time for the source MAC address m1 through the port P4 is ignored in terms of the MAC movement. Additionally, when the comparison result of the port identification information comparison step 240 is that the port identification information is the same, a final reception time update step 290 is performed to update the final reception time information of the source MAC address with the reception time T1 of the current frame.

The guard threshold HTT may have a value that is empirically determined in consideration of network characteristics applied thereto. The value of the guard threshold HTT may depend on a delay of a corresponding network on a special associated network path. A manager sets an appropriate HTT value for the network switch in consideration of the delay on the path.

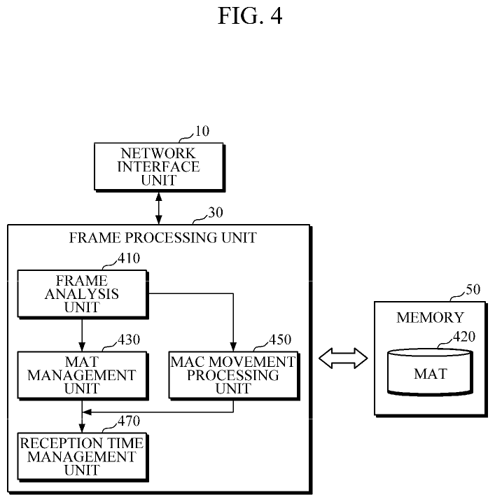

FIG. 4 is a block diagram showing a detailed configuration of the network switch according to an embodiment. The network switch according to an embodiment includes a network interface unit 10, a memory 50, and a frame processing unit 30. In an embodiment, the frame processing unit 30 includes a frame analysis unit 410 and a MAC movement processing unit 450. The frame analysis unit 410 analyzes the source MAC address of the received frame and the port that has received the frame. First, the frame analysis unit 410 analyzes whether the received frame has a new source MAC address. In addition, the frame analysis unit 410 analyzes whether the port that has received the frame matches the previous receiving port for the MAC address.

According to an aspect, the frame processing unit 30 includes the MAC movement processing unit 450. When the frame analysis unit 410 determines that the port that has received the frame is different from the previous receiving port for the MAC address, the MAC movement processing unit 450 compares the difference between the time at which the frame is finally received from the source MAC address and the time at which the current frame is received to the guard threshold. When the comparison result is that the difference is greater than the guard threshold, the MAC movement processing unit 450 updates the port identification information recorded for the source MAC address with the identification information of the current receiving port. When the difference is smaller than the guard threshold, the MAC movement processing unit 450 does not update the receiving port information regarding the receiving port for the MAC address.

According to an additional aspect, the frame processing unit 30 may further include a reception time management unit 470. When the frame analysis unit 410 determines that the port that has received the frame is the same as the previous receiving port for the MAC address, the reception time management unit 470 updates information regarding the time at which the MAC address is finally received with the time at which the current frame is received.

According to an additional aspect, the frame processing unit 30 may further include a MAT management unit 430. When the frame analysis unit 410 searches the MAT for the source MAC address of the received frame but does not find the source MAC address, the MAT management unit 430 adds, to the MAT, the source MAC address and identification information of the port that has received the frame.

According to the proposed invention, it is possible to avoid unnecessary MAC movement. Furthermore, generally, a packet that is infinitely circulated on a loop is repeatedly forwarded in a specific switch for a very short time. Thus, according to the proposed invention, it is possible to improve switch efficiency by removing the loop circulation because the packet is no longer routed as well as to avoid the MAC movement due to the packet

The present invention has been described above with reference to embodiments referring to the accompanying drawings, but is not limited thereto. Rather, the present invention should be construed as encompassing various modifications that may be apparent to those skilled in the art. The described aspects may be freely combined without contradiction, and such combinations are also included in the scope of the present invention.

The appended claims are intended to cover such combinations and omitted or simplified embodiments, but the present invention does not claim all such combinations, and the combinations should be allowed to fall into the scope of the present invention through future amendments.

What is claimed is:

1. A data frame processing method of a network switch, the data frame processing method comprising:
a frame receiving operation of receiving a frame through one port;
a port identification information comparison operation of comparing port identification information recorded for a source media access control (MAC) address of the received frame to identification information of a port that has received a current frame, with reference to a MAC address table (MAT);
a threshold comparison operation of comparing a difference between a time at which the frame was finally received from the source MAC address and a time at which a current frame is received to a guard threshold when a result of the comparison is that the recorded port identification information is different from the identification information of the port; and
a MAC movement processing operation comprising a port identification information update operation of updating the port identification information for the source MAC address with the identification information of the port that has received the current frame when the difference is greater than the guard threshold and comprising a MAC movement prevention operation of preventing the port identification information from being updated when the difference is smaller than the guard threshold.

2. The data frame processing method of claim 1, further comprising a final reception time update operation of updating final reception time information for the source MAC address with the time at which the current frame is received when a result of the comparison in the port identification information comparison operation is that the recorded port identification information is the same as the identification information of the port.

3. The data frame processing method of claim 1, further comprising, between the frame receiving operation and the port identification information comparison operation:
a source MAC search operation of searching the MAT for the source MAC address of the received frame;
an operation of proceeding to the port identification information comparison operation when the source MAC address is found; and
a MAT entry addition operation of adding, to the MAT, the source MAC address and the identification information of the port that has received the frame.

4. The data frame processing method of claim 3, further comprising a final reception time record operation of recording information regarding the time at which the current frame is received in the final reception time information for the source MAC address as well as performing the MAT entry addition operation when the source MAC address is not found in the source MAC search operation.

5. A network switch comprising:
a network interface unit having a plurality of ports for receiving frames;
a memory configured to store a media access control (MAC) address table (MAT); and
a frame processing unit configured to receive a frame through one of the plurality of ports, analyze the received frame, and send the received frame to another port,
wherein the frame processing unit comprises:
a frame analysis unit configured to analyze a source MAC address of the received frame and the port that has received the frame; and
a MAC movement processing unit configured to compare a difference between a time at which the frame was finally received from the source MAC address and a time at which a current frame is received to a guard threshold when the frame analysis unit determines that the port that has received the frame is different from a previous receiving port for the MAC address, configured to update port identification information recorded for the source MAC address with identification information of a port that has received the current frame when the difference is greater than the guard threshold, and configured to prevent the port identification information from being updated when the difference is smaller than the guard threshold.

6. The network switch of claim 5, wherein the frame processing unit further comprises a reception time management unit configured to update final reception time information for the MAC address with a time at which the current frame is received when the frame analysis unit determines that the port that has received the frame is the same as the previous receiving port for the MAC address.

7. The network switch of claim 5, further comprising a MAT management unit configured to add, to the MAT, the source MAC address and identification information of the port that has received the frame when the source MAC address of the frame received by the frame analysis unit is not found in the MAT.
